(19) United States
(12) Patent Application Publication
(10) Pub. No.: US 2017/0016387 A1
(43) Pub. Date: Jan. 19, 2017

(54) Internal Combustion Engine with Integrated Air Compressor

(71) Applicant: Tonand Inc., London (CA)

(72) Inventor: Antonio Cannata, London (CA)

(21) Appl. No.: 15/211,816

(22) Filed: Jul. 15, 2016

Related U.S. Application Data
(60) Provisional application No. 62/194,017, filed on Jul. 17, 2015.

(51) Int. Cl. F02B 33/14; F02B 33/30; F02B 33/44; F02D 41/00; F01L 9/04; F02B 75/02; F02D 41/26; F02B 75/28; F01L 1/047

(52) U.S. Cl. CPC F02B 33/14; F02B 75/28; F02B 33/30; F02B 33/44; F01L 1/047; F01L 9/04; F02B 75/02; F02D 41/26; F02D 41/009; F02B 2075/025; F02B 2075/027

(57) ABSTRACT

A piston-cylinder arrangement for an internal combustion engine includes a first cylinder bore in an engine with a first piston disposed therein. A combustion chamber may be positioned between walls of the first cylinder bore and the first piston. A second cylinder bore in the engine block may be aligned with the first cylinder bore with a second piston disposed therein. A compression chamber may be positioned between walls of the second cylinder bore and the second piston. One or more supporting members may connect the first piston to the second piston for facilitating concurrent reciprocation of the first piston and the second piston within their respective cylinder bores during operation of the internal combustion engine. The first piston, the second piston, and the one or more supporting members may define a stacked piston arrangement.

### PRIORITY

The present disclosure claims priority to and the benefit of the filing date of U.S. Provisional Application No. 62/194,017, filed Jul. 17, 2015, titled Internal Combustion Engine With Integrated Air Compressor, incorporated herein in its entirety by reference.

### FIELD

The present disclosure relates to piston configurations of internal combustion engines.

### BACKGROUND

The provision of compressed air in internal combustion engines is traditionally supplied via an air compression device that is separate from reciprocating pistons used in fuel combustion. Examples of these air compression devices are air compressors run off of engine power (e.g. for supplying air brakes), a turbo charger, and/or a supercharger. For example, most of today's commercial transportation depends on diesel engines and air brakes, whereby air pressure is provided by an engine driven air compressor. These compressors, on the average, are actuated every eleven minutes and use some engine horsepower to do so.

Given the current state of the art for engine driven air compression devices, disadvantages are apparent with respect to available delivery speed and volumes for vehicle combustion, air braking, and/or engine braking requirements. Further, traditional superchargers and turbo chargers are not easily configurable for disconnection when not needed during power cycles of the engine and therefore provide constant or otherwise undesirable parasitic losses.

It is also recognized that for current engine air braking applications, all the compressing and release of air used during engine braking takes place in the fuel burning chamber, giving the disadvantage of negatively affecting the emission system. These disadvantages include increased emissions by expelling unburned fuels and cooling off catalytic converters and other exhaust components.

Further, it is recognized that two stroke engine operation has a disadvantage in terms of poor emission quality. As such, current two stroke internal combustion engines are less efficient than four stroke engines for a number of different reasons; (1) they don't breath well, a four stroke engines has 180° to exhaust and 180° to intake while a two stoke has about 80 to 100° to do both at the same time; (2) using a scavenged design crankcase it is difficult to pass emissions standards, even with direct fuel inject, thanks to the total-loss oiling; and (3) by using a blower charger engine, power is stolen while still retaining exhaust and intake limitations.

### SUMMARY

It is an object of the present invention to provide a piston configuration to obviate or mitigate at least some of the above-presented disadvantages.

A first aspect provided is a piston-cylinder arrangement for an internal combustion engine, the arrangement comprising: a first cylinder bore in an engine block, the first cylinder bore having an axis extending along a length of the first cylinder bore; a first piston positioned within the first cylinder bore for reciprocation along the axis; a combustion chamber positioned between walls of the first cylinder bore and the first piston; an inlet for directing intake contents into the combustion chamber; an outlet for directing exhaust contents of the combustion chamber out of the combustion chamber; a second cylinder bore in the engine block, the second cylinder bore aligned with the first cylinder bore along the axis; a second piston positioned within the second cylinder bore for reciprocation along the axis; a compression chamber positioned between walls of the second cylinder bore and the second piston; one or more ports in the engine block for directing air into and out of the compression chamber; and one or more supporting members connecting the first piston to the second piston, the one or more supporting members positioning the first piston and the second piston is a spaced apart relationship for facilitating concurrent reciprocation of the first piston and the second piston within their respective cylinder bores during operation of the internal combustion engine; wherein the first piston, the second piston and the one or more supporting members define a stacked piston arrangement.

A second aspect provided is a control system having a computer processor and associated memory programmed by a set of stored instructions for executing the instructions to operate in a power cycle using two strokes of the stacked piston arrangement as: during a first stroke of the two strokes of the power cycle, the first stroke including travel of the stacked piston arrangement from TDC to BDC: receiving via the position sensing system a signal that the stacked piston is adjacent to TDC; providing for inlet of air from ambient into the compression chamber; opening the tank supply control valve to supply compressed air from the air storage tank to the air inlet port for injection into the combustion chamber via the inlet, the compressed air for use in mixing with fuel for facilitating combustion in the combustion chamber during the first stroke; and during a second stroke of the two strokes of the power cycle, the second stroke including travel of the stacked piston arrangement from BDC to TDC: assessing if air pressure of the air storage tank is above a pressure threshold, and if so then venting the air storage tank; wherein exhaust contents present in the combustion chamber are expelled from the combustion chamber during the second stroke through operation of an exhaust valve in the outlet via the valve control system.

A third aspect provided is a control system having a computer processor and associated memory programmed by a set of stored instructions for executing the instructions to operate in a power cycle of the stacked piston arrangement as: receiving via the position sensing system a signal that the stacked piston arrangement is in position for travel towards BDC; opening the tank control valve to supply compressed air from the air storage tank into the compression chamber; and closing the tank control valve to inhibit the supply of compressed air into the compression chamber during travel of the stacked piston arrangement towards TDC; wherein supply of compressed air in the first supply line from the compression chamber to the air storage tank is inhibited by an outlet valve positioned between the compression chamber and the air storage tank while air pressure introduced by the supply of compressed air into the compression chamber biases travel of the stacked piston arrangement towards BDC.

A fourth aspect provided is a control system having a computer processor and associated memory programmed by a set of stored instructions for executing the instructions to operate in a power cycle of the stacked piston arrangement as: receiving via the position sensing system a signal that the stacked piston arrangement is in position for travel towards BDC; opening at least one of the tank control valve and the ambient control valve to supply air into the compression chamber; and closing the at least one of the tank control valve and the ambient control valve to inhibit egress of air from the compression chamber during travel of the stacked piston arrangement towards TDC; wherein the compression of air in the compression chamber during travel of the stacked piston arrangement towards TDC biases travel of the stacked piston arrangement against travel towards TDC during operation of intake and exhaust in the combustion chamber.

A fifth aspect provided is a control system having a computer processor and associated memory programmed by a set of stored instructions for executing the instructions to operate in a power cycle using four strokes of the stacked piston arrangement as: during a first stroke of the four strokes of the power cycle, the first stroke including travel of the stacked piston arrangement from TDC to BDC: receiving via the position sensing system a signal that the stacked piston is adjacent to TDC; providing for inlet of air from ambient into the compression chamber; opening the tank supply control valve to supply compressed air from the air storage tank to the air inlet port for injection into the combustion chamber via the inlet, the compressed air for use in mixing with fuel for facilitating combustion in the combustion chamber during a second stroke of the power cycle; and during at least one of a second stroke and a fourth stroke of the power cycle, the second stroke and the fourth stroke including travel of the stacked piston arrangement from BDC to TDC: assessing if air pressure of the air storage tank is above a pressure threshold, and if so then venting the air storage tank; wherein exhaust contents present in the combustion chamber are expelled from the combustion chamber during the fourth stroke through operation of an exhaust valve in the outlet via the valve control system.

A sixth aspect provided is the set of stored instructions to operate in the power cycle during at least one of the second stroke and the fourth stroke of the power cycle as: opening the ambient control valve to direct the air out of the compression chamber into ambient rather than into the air storage tank via the first port.

A seventh aspect provided is the set of stored instructions to operate in the power cycle as: positioning the tank supply control valve as closed over a number of the power cycles in series in order to inhibit the supply of compressed air into the inlet while increasing the air pressure in the air storage tank; wherein the internal combustion engine operates in a normally aspirated mode using ambient air collected via the inlet.

### BRIEF DESCRIPTION OF THE DRAWINGS

The foregoing and other aspects will now be described by way of example only with reference to the attached drawings, in which:

FIG. 1 is a cross sectional view of a piston cylinder arrangement of an internal combustion engine;

FIG. 2 is a further view of the piston cylinder arrangement shown in FIG. 1;

FIG. 3 shows a control system for the piston cylinder arrangement shown in FIG. 1;

FIG. 4 is a further view of the piston cylinder arrangement in FIG. 1, in a state of compressed air exhaust; and

FIG. 5 is a further view of the piston cylinder arrangement in FIG. 1, in a state of air intake.

### DETAILED DESCRIPTION OF PREFERRED EMBODIMENTS

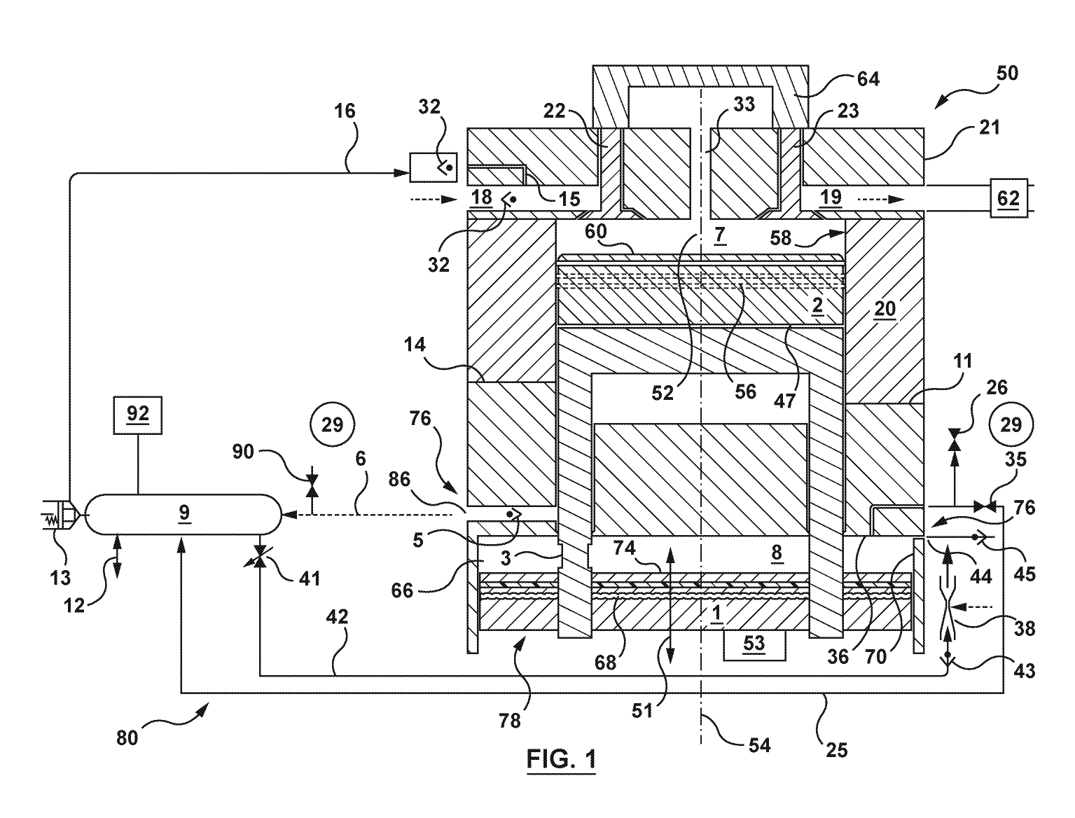

Referring to FIG. 1, shown is a piston-cylinder arrangement 50 for an internal combustion engine (not shown). The arrangement 50 has an engine block 20 with a cylinder head 21. It is recognised that one cylinder of the engine block 20 is shown for exemplary purposes only, recognising that the engine block 20 could have a plurality of piston-cylinder arrangements 50 as desired. It is recognised that the engine block 20 can be incorporated as part of an engine for a vehicle or other application (e.g. generator), as desired. It is also recognised that fuel and corresponding ignition configuration of the engine can be provided as petrol, diesel, propane, hydrogen, or other combustible fuel as desired.

Referring again to FIG. 1, the engine block 20 has a first cylinder bore 52 having an axis 54 extending along a length of the cylinder bore 52, the axis 54 for accommodating reciprocation of a first piston 2 therein. The piston 2 is positioned within the cylinder bore 52 for reciprocation along the axis 54 and has piston rings 56 for contacting with walls 58 of the cylinder bore 52. The piston 2 can also have lubricating oil passages 47 for facilitating lubrication of the walls 58. The piston 2, cylinder head 21 and cylinder bore 52 cooperate to form a combustion chamber 7, positioned between walls 58 of the cylinder bore 52, head surface 60 of the piston 2 and cylinder head 21.

The cylinder head 21 has an inlet 18 for directing intake contents (e.g. air and fuel) into the combustion chamber 7, as controlled by an engine intake valve 22. The cylinder head 21 also has an outlet 19 for directing exhaust contents (e.g. combustion products) of the combustion chamber 7 out of the combustion chamber 7 and into an exhaust system 62 (e.g. exhaust manifold, exhaust pipes, catalytic converter, muffler, emissions sensors, etc.). Timing of ejection of the exhaust contents from the combustion chamber 7 is controlled via an engine exhaust valve 23. A valve control system 64 is coupled to the valves 22, 23 for coordinating opening and closing of the inlet valve 22 of the inlet 18 and the exhaust valve 23 of the outlet 19 based on power cycle intake and exhaust timing. It is recognised that examples of the valve control system 64 can include a valve actuator such as a cam shaft and/or an electronically or pneumatic controlled valve actuator (e.g. solenoid), as is known in the art.

Referring again to FIG. 1, the piston-cylinder arrangement 50 also has a second cylinder bore 66 in the engine block 20, the second cylinder bore 66 aligned with the first cylinder bore 52 along the axis 54. A second piston 1 is positioned within the cylinder bore 66 for reciprocation along the axis 54 and has piston rings 68 for contacting with walls 70 of the cylinder bore 66. The piston 1, the engine block 20 and cylinder bore 66 cooperate to form a compression chamber 8, positioned between walls 70 of the cylinder bore 66, head surface 74 of the piston 1 and the engine block 20. Provided are one or more ports 76 in the engine block 20 for directing air into and/or out of the compression chamber 8, as further described below.

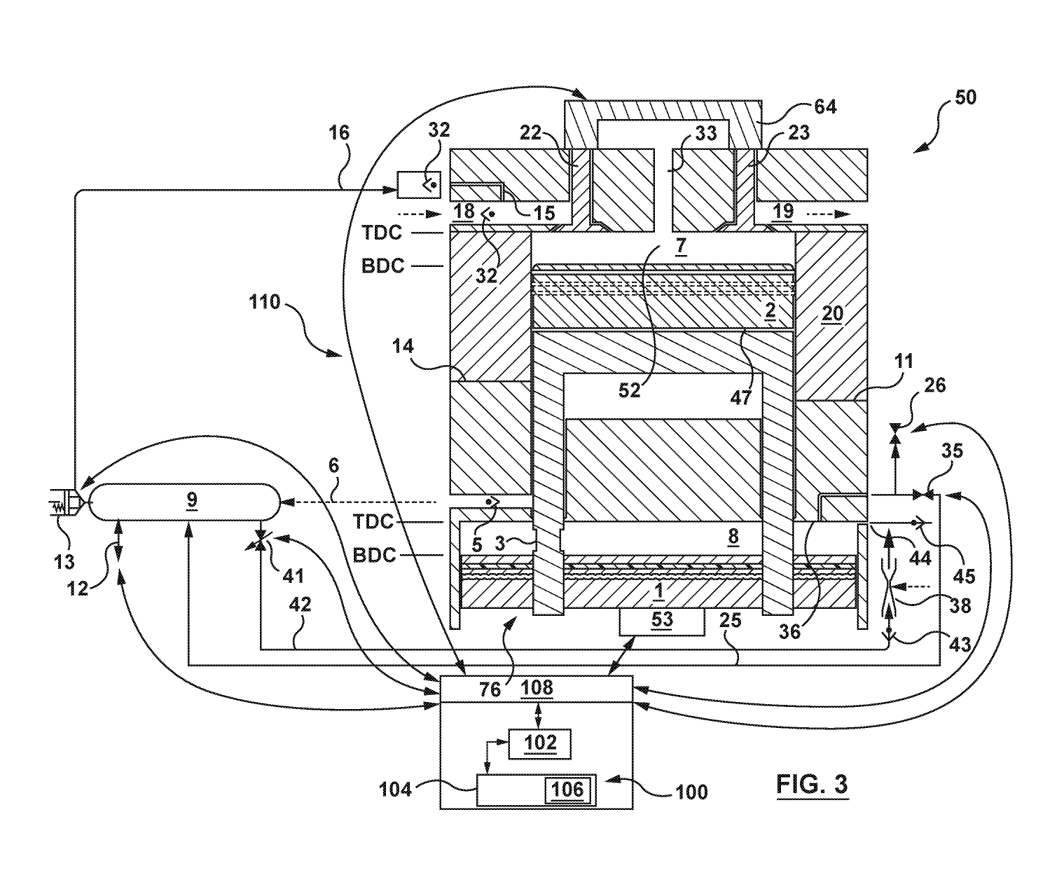

The compression chamber 8 is used to provide a source of compressed air (due to air intake and compression strokes of piston 1 in cylinder bore 66 during reciprocation) for use in a number of potential operations. These operations can include such as but not limited to: air boost (i.e. providing variable compression ratios VCR as dictated by the varying the amount of compressed air introduced) to supplement air supplied to the combustion chamber 7 similar to a turbocharger or supercharger operation; compressed air supply for operation of pneumatically powered vehicle components 92 such as air brakes or other vehicle components operated by compressed air; assisted engine startup by forcing piston 1 from TDC to BDC (see FIG. 3) using compressed air forced into the compression chamber 8, hence pneumatic startup of the stacked piston arrangement 78 (piston 1 mechanically coupled and fixedly positioned with respect to piston 2); aggressive engine braking by forcing compressed air from the air storage tank 9 into the compression chamber 8 for further compression in travel of the piston 1 from BDC to TDC; and/or assisted engine braking by drawing ambient air into the compression chamber 8 for compression in travel of the piston 1 from BDC to TDC. It is recognized that use of compressed air generated by the compression chamber 8 can be provided for in separated and independent air supply circuits 82,84, as further described below, thus advantageously facilitating compressed air for VCR to remain separate from compressed air used for non VCR applications (e.g. engine braking, pneumatic operations, etc.).

Referring again to FIG. 1, the first piston 2 and the second piston 1 are positioned in a spaced apart relationship by one or more supporting members 4 connecting the first piston 2 to the second piston 1, for facilitating concurrent reciprocation of the first piston 2 and the second piston 1 within their respective cylinder bores 52, 66 during operation of the internal combustion engine. Together, the first piston 2, the second piston 1 and the one or more supporting members 4 define the stacked piston arrangement 78.

The stacked piston arrangement 78 can be monitored for location in the respective cylinder bores 52,66 by a position sensing system 53 for sensing position of the stacked piston arrangement 78 with respect to respective Top Dead Center (TDC) and respective Bottom Dead Center (BDC) of the cylinder bores 52,66. It is recognized that the position sensing system 53 can be part of the valve control system 64, as desired, or otherwise separate there from (e.g. positioned with respect to a crankshaft connecting the second piston 1 to a load such as a vehicle driveshaft—not shown).

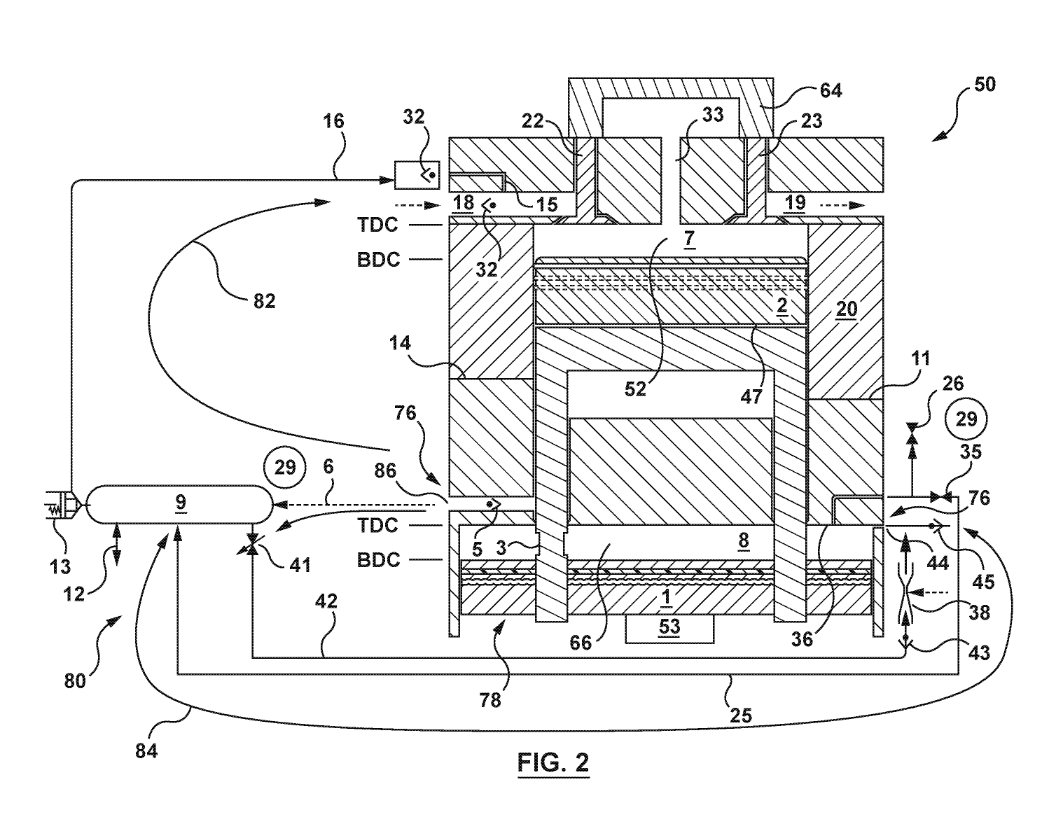

Referring again to FIG. 1, shown is an air system 80 for coordinating air flow into and out of the compression chamber 8. As further discussed below, there are a number of optional configurations for the air system 80. In one example, the air system 80 can have an air supply circuit 82 (see FIG. 2) for providing compressed air obtained from the compression chamber 8 into the engine inlet 18. It is recognized in this embodiment that the air system 80 can be used to provide supplemental air (i.e. compressed air) to the combustion chamber 7 in addition to what air is provided to the combustion chamber via normal aspiration from ambient 29. In another example, the air system 80 can also have air supply circuit 84 for collecting compressed air from the compression chamber 8 as well as introducing compressed air to the compression chamber 8 based on operational states and requirements of the engine. As further discussed below, air supply circuit 84 can be used to direct compressed air from the compression chamber 8 to an air storage tank 9 for storage, as well as to direct compressed air from the air storage tank 9 to the compression chamber 8.

Referring to FIG. 2, the air supply circuit 82 can include an air injection port 15 coupled to the inlet 18 for directing compressed air from the compression chamber 8 into the combustion chamber 7. The compressed air storage tank 9 can be positioned between the one or more ports 76 and the air injection port 15, such that the compressed air storage tank 9 is fluidly connected to the one or more ports 76 by a first supply line 6 and fluidly connected to the air injection port 15 by a second supply line 16. The air storage tank 9 has a control valve 13 (e.g. solenoid valve) for operation by a air supply control system 100 (see FIG. 3) as further described below. As such, timed opening and closing of the control valve 13 provides for injection of compressed air into the inlet 18 of the combustion chamber 7 via supply line 16. For example, supply line 16 can be fluidly connected to a conduit 15 present in the cylinder head 21 (as shown) and/or present in the engine block 20 (not shown), as desired. The supply line 16 and the inlet 18 can have one or more control valves 32 (e.g. directional valves) for coordinating the directional supply of the compressed air to the combustion chamber 7. For example, the directional valve 32 in the inlet 18, between the inlet valve 22 and ambient 29, can provide for inhibiting flow of the compressed air from the conduit 15 to ambient 29. Accordingly, the tank supply control valve 13 controls the supply of compressed air in the supply line 16 from the air storage tank 9 to the air injection port 15 and the outlet valve 5 facilitates the supply of compressed air in the supply line 6 from the compression chamber 8 to the air storage tank 9 during the compression stroke (e.g. travel from BDC to TDC) of the piston 1.

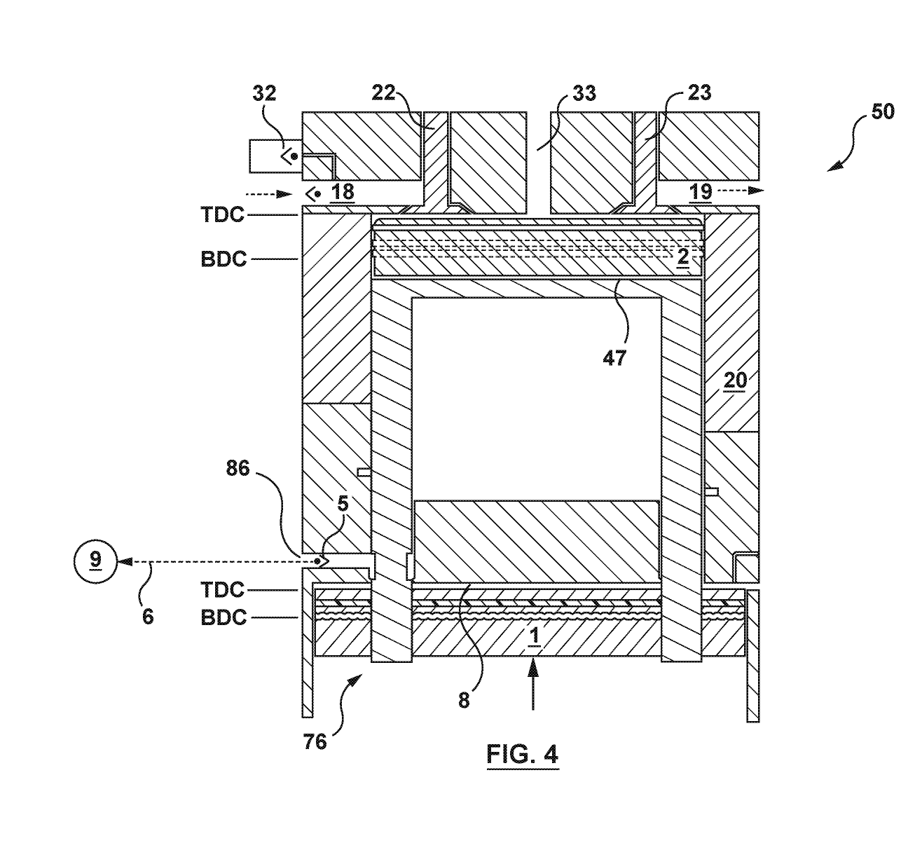

Referring again to FIG. 1, the one or more ports 76 can include a first port 86 for directing compressed air from the compression chamber 8 to the air storage tank 9, the first port 86 cooperating with a release port 3 positioned in the one or more supporting members 4, wherein periodic alignment (see FIG. 3) between first port 86 and the release port 3 during reciprocation 51 of the second piston 1 provides for exhaust of compressed air out of the compression chamber 8 and into the air storage tank 9 via supply line 6. As shown by example, the release port 3 can be provided as one or more notches in the body of the supporting members 4 (e.g. columns used to space apart piston 2 from piston 1 along the axis 54). As shown in FIG. 4, alignment of the release port 3 in the supporting member 4 with the first port 86 in the engine block 20 provides for fluidly connecting the compressed air contents of the compression chamber 8 with the supply line 6. As shown by example, the supply line 6 and/or the first port 86 can include a valve 5 (e.g. directional valve) for inhibiting backflow of compressed air from the air storage tank 9 to the compression chamber 8, or otherwise facilitating the flow of compressed air from the compression chamber 8 to the air storage tank 9 when the release port 3 and the first port 86 are aligned.

Referring again to FIG. 2, the air supply circuit 84 can include the first port 86 to direct compressed air out of the compression chamber 8 as well as the one or more ports including a second port 36 for directing air with respect to the compression chamber 8 via an ambient control valve 26 coupled to ambient 29. As such, the compression chamber 8 can be supplied by intake air from ambient 29 during an intake stroke of the piston 1 through the second port 36. Also, the compression chamber 8 can direct air out of the compression chamber 8 and into the air storage tank via tank control valve 35 using supply line 25 fluidly connected to valve 35 and the air supply tank 9. The air supply circuit 84 can also include a third supply line 42 coupling the air supply tank 9 to an inlet 44 of the compression chamber 8. Using control valve 41, the compressed air in the air storage tank 9 can be injected into the compression chamber 8 via air inlet 44. Injection of compressed air via air inlet 44 can be used to fill the compression chamber 8 from the air storage tank 9 and thus bias the travel of the piston 1 from TDC to BDC, as further discussed below.

Referring again to FIG. 2, it is noted that the exhaust system 62 coupled to the outlet 19 of the combustion chamber 7 is used to direct the combustion gases to ambient, while at the same time the air supply circuit 84 can be used to configure the one or more ports 76 in the engine block 20 to direct air out of the compression chamber 8 to ambient 29 in a fluid path that bypasses the exhaust system 62. As such, it is recognized that the compressed air generated by reciprocation of the piston 1 can be exhausted to ambient 29 via the second port 36 and the ambient control valve 26, rather than being injected via the inlet 18 through the combustion chamber 7 and exhausted to ambient via the outlet 19 and coupled exhaust system 62. The combustion chamber 8 bypass provided by the air supply circuit 84 can be advantageous in air braking applications, as described below, as compressed air from the storage tank 9 can be used independently for air braking via introduction into the compression chamber 8 via air port 44 of the air supply circuit 84, which is fluidly separate from the air supply circuit 82 used to supply the combustion chamber 7 to supplement combustion of fuel therein. In other words, compressed air used for air braking can remain uncontaminated by combusted fuel as the air supply circuits 82,84 provide separated and independent fluid paths to ambient 29 for the compressed air obtained from the air storage tank 9.

Referring to FIGS. 1, 2 and 3, shown is the control system 100 having a computer processor 102 and associated memory 104 programmed by a set of stored instructions 106 for executing the instructions 106 to operate in a power cycle using two strokes of the stacked piston arrangement 78. The control system 100 has an interface 108 for receiving and providing control signals 110 based on information 110 provided by the position sensing system 53, the valve control system 64, states of the various valves (e.g. valves 5, 13, 26, 32, 35, 41, 43), and/or tank 9 pressure monitored by pressure sensor 12.

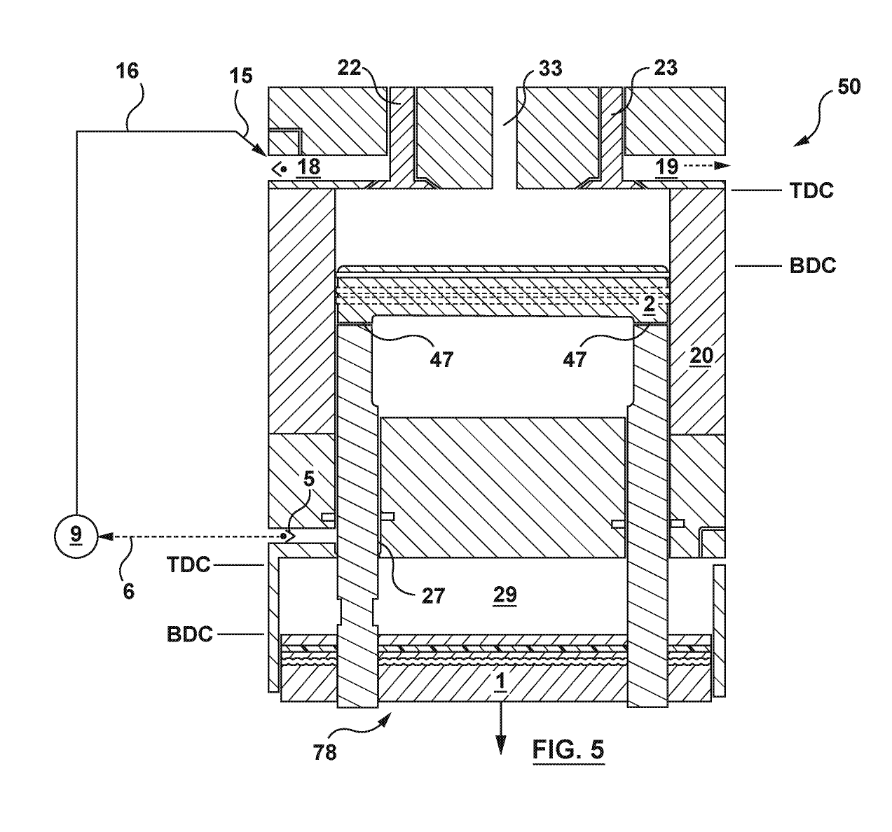

In operation of the stacked piston arrangement 78, during a first stroke of the two strokes of the power cycle, the first stroke including travel of the stacked piston arrangement 78 from TDC to BDC (see FIG. 5), the control system 100 executes the instructions 106 to: receive via the position sensing system 53 a signal 110 that the stacked piston arrangement 78 is adjacent to TDC; provide for inlet of air from ambient 29 into the compression chamber 8 via operation of the control valve 26 when the piston 1 travels as an intake stroke towards BDC; and open the tank supply control valve 13 to supply compressed air from the air storage tank 9 to the air inlet port 15 for injection into the combustion chamber 7 via the inlet 18, the compressed air for use in mixing with fuel for facilitating combustion in the combustion chamber during the first stroke.

In this manner, the travel of the stacked piston arrangement 78 provides concurrently for 1) injection of ambient air through air port 36 for piston 1 operating as an intake stroke (i.e. drawing air from ambient 29 into the compression chamber 8 and 2) injection of compressed air into the combustion chamber 7 for use in subsequent combustion of fuel (i.e. power stroke) to force the piston 2 from TDC to BDC.

In operation of the stacked piston arrangement 78, during a second stroke of the two strokes of the power cycle, the second stroke including travel of the stacked piston arrangement 78 from BDC to TDC (see FIG. 4), the control system 100 can optionally execute the instructions 106 to: assess if air pressure of the air storage tank 9 via the pressure sensor 12 is above a pressure threshold, and if so then venting the air storage tank 9.

It is recognized that that venting of the air storage tank 9 can be achieved by using any appropriate supply line 16, 42, 25 to provide a path of exit (and thus pressure decrease) for compressed air from the air storage tank 9. It is recognized that the air storage tank 9 could also be vented to ambient 29 using a pressure relief valve coupled to the tank 9, not shown. It is noted that as the stacked piston arrangement 78 travels from BDC to TDC, compressed air is generated in the compression chamber 8 due to travel of the piston 1 therein and control valve 26 to ambient is closed. Once the travel of the piston 1 causes alignment of the release port 3 and the air port 86, the generated compressed air is supplied to the air storage tank 9 via supply line 6. Alternatively to the above, it is recognized that the supply line 6 can optionally include a pressure relief valve 90 to vent to ambient 29, as desired. It is also recognized that during the second stroke of the power cycle, exhaust contents present in the combustion chamber 7 are expelled from the combustion chamber 7 during through operation of the exhaust valve 23 in the outlet 19 via the valve control system 64.

Options of control exercised by the control system 100 during operation the stacked piston arrangement 78 during the power cycle can include: the ambient control valve 26 is opened to facilitate the venting of the compression chamber 8 to inhibit compression of air in the compression chamber 8 during travel of the stacked piston arrangement 78 from BDC to TDC; the stacked piston arrangement 78 is traveling towards TDC when the tank supply control valve 13 is opened to supply the air inlet port 15 in order to provide compressed air from the air storage tank 9 to the combustion chamber 7; and the stacked piston arrangement 78 is traveling towards BDC when the tank supply control valve 13 is opened to supply the air inlet port 15 in order to provide compressed air from the air storage tank 9 to the combustion chamber 7.

In cases where engine power demand does not need an additional boost of air provided by the compressed air sent to air injection port 15, the engine can operate in a normally aspirated manner, e.g. obtain air supply requirements for combustion of the fuel from the air inlet 18 using air obtained from ambient. In this manner, the set of stored instructions executed by the control system 100 would operate the stacked piston arrangement 78 during the first stroke of the two strokes of the power cycle as: positioning the tank supply control valve 13 as closed in order to inhibit the supply of compressed air into the inlet 18 via the air injection port 15; wherein the internal combustion engine operates in a normally aspirated mode using ambient air collected via the inlet 18. This mode can be used to charge the air storage tank 9 with compressed air, e.g. during engine idle, so that the air storage tank 9 can have compressed air of sufficient quantity for vehicle operations (e.g. operation of air brakes, operation of engine braking, air assisted engine starting, etc.). In this manner, the set of stored instructions executed by the control system 100 would operate the stacked piston arrangement 78 during multiple strokes of multiple power cycles as: positioning the tank supply control valve 13 as closed over a number of the power cycles in series in order to inhibit the supply of compressed air into the inlet 15 while increasing the air pressure in the air storage tank 9; wherein the internal combustion engine operates in a normally aspirated mode using ambient air 29 collected via the inlet 18.

If the control system 100 desires to vent the compression chamber 8 to ambient 29 rather than to direct the compressed air to the air storage tank 9 during travel of the piston 1 from BDC to TDC, the control system 100 would position the second port 36 to direct air with respect to the compression chamber 8 via the ambient control valve 26 coupled to ambient 29, recognizing that the second port 36 can be separate from the first port 86.

As discussed above, the provision of the independent air supply circuits 82,84 having different independent paths to ambient 29 for compressed air sourced from the air supply tank 9 (e.g. via the exhaust system 62 if exiting the combustion chamber 7 or via the control valves 26,90 if exiting the compression chamber 8 without entrance into the combustion chamber 7) facilitates operation of air boost when demanded by the engine while at the same time providing for circumstances where the one or more ports 76 in the engine block 20 can direct air out of the compression chamber 8 while bypassing the exhaust system 62 by second port 36 for directing air with respect to the compression chamber 8 via the ambient control valve 26 coupled to ambient 29. Alternatively, the one or more ports 76 in the engine block 20 can direct air out of the compression chamber 8 while bypassing the exhaust system 62 by the second port 36 being fluidly connected to the air storage tank 9 via the tank control valve 35, such that air is circulated between the air storage tank 9 and the compression chamber 8 using the first port 86 and the second port 36 of air supply circuit 84.

It is also recognized in the above that the stacked piston arrangement 78 can be incorporated into a four stroke power cycle, rather than the two stroke power cycle as provided by example. In this case, the combustion chamber 7 would experience an intake stroke, a compression stroke, a power stroke and an exhaust stroke in the four stroke power cycle. It should be recognized that during the four stroke power cycle, compression chamber 8 would be supplied by air (intake) during the intake stroke, would exhaust air (exhaust) during the compression stroke, would be again supplied by air (intake) during the power stroke, and would again exhaust air (exhaust) during the exhaust stroke, as the pistons 1, 2 are coupled in reciprocation due to the supporting members 4. The air supply circuit 82 could be used by the control system 100 to provide compressed air via tank supply control valve 13 to the air inlet port 15 for use in the intake stroke of the four stroke power cycle. It is recognized that the compression stroke and exhaust stroke would be used by the piston 1 to concurrently compress air and supply to the air storage tank 9 (via air port 86 and/or control valve 35) and/or vent the air exhausted from the compression chamber 8 to ambient 29 (via air port 36 and control valve 26 and/or air port 86 and valve 90). Similarly, the intake and power strokes of the four stroke power cycle would be used to draw air from ambient 29 (via port 36) and/or from the air storage tank 9 (via port 44).

For example, the stacked piston arrangement 78 can be operated by a control system 100 having the computer processor 102 and associated memory 104 programmed by a set of stored instructions 106 for executing the instructions 106 to operate in a power cycle using four strokes of the stacked piston arrangement 78 as: during a first stroke of the four strokes of the power cycle, the first stroke including travel of the stacked piston arrangement 78 from TDC to BDC: receiving via the position sensing system 53 a signal that the stacked piston 78 is adjacent to TDC; providing for inlet of air from ambient 29 into the compression chamber 8; opening the tank supply control valve 13 to supply compressed air from the air storage tank 9 to the air inlet port 15 for injection into the combustion chamber 7 via the inlet 18, the compressed air for use in mixing with fuel for facilitating combustion in the combustion chamber 7 during a second stroke of the power cycle; and during at least one of a second stroke and a fourth stroke of the power cycle, the second stroke and the fourth stroke including travel of the stacked piston arrangement from BDC to TDC: assessing if air pressure of the air storage tank 9 is above a pressure threshold, and if so then venting the air storage tank 9; wherein exhaust contents present in the combustion chamber 7 are expelled from the combustion chamber 7 during the fourth stroke through operation of an exhaust valve 23 in the outlet 19 via the valve control system 64.

Further, it is recognized that in the four stroke embodiment of the power cycle, the ambient control valve 26 can be opened to facilitate the venting. Further, when the stacked piston arrangement 78 can be traveling towards TDC when the tank supply control valve 13 is opened. Alternatively, the stacked piston arrangement 78 can be traveling towards BDC when the tank supply control valve 13 is opened. Also contemplated is the set of stored instructions 106 to operate in the power cycle during the first stroke of the four strokes of the power cycle as: positioning the tank supply control valve 13 as closed in order to inhibit the supply of compressed air into the inlet 18; wherein the internal combustion engine operates in a normally aspirated mode using ambient air collected via the inlet 18. Also contemplated is the set of stored instructions 106 to operate in the power cycle during at least one of the second stroke and the fourth stroke of the power cycle as: opening the ambient control valve 26 to direct the air out of the compression chamber 8 into ambient 29 rather than into the air storage tank 9 via the first port 86. Further contemplated is the set of stored instructions 106 to operate in the power cycle as: positioning the tank supply control valve 13 as closed over a number of the power cycles in series in order to inhibit the supply of compressed air into the inlet 18 while increasing the air pressure in the air storage tank 9; wherein the internal combustion engine operates in a normally aspirated mode using ambient air collected via the inlet 18.

Further, as discussed above, the stacked piston arrangement 78 can be operated using air supply circuit 82 (e.g. for VCR applications) and/or can be operated using air supply circuit 84 (e.g. for engine braking or pneumatic operations). Provided below is an example of the stacked piston arrangement 78 in conjunction with using air supply circuit 84

As noted above, the air supply circuit 82 can be optional and as such the air storage tank 9 could be dedicated for use in air supply circuit 84 having the compressed air storage tank 9 fluidly connected to the one or more ports 76 by the first supply line 6 for storing compressed air generated during operation of the internal combustion engine. The one or more ports 76 could include the first port 86 for directing compressed air from the compression chamber 8 to the air storage tank 9, the first port 86 cooperating with the release port 3 positioned in the one or more supporting members 4, wherein periodic alignment between first port 86 and the release port 3 during reciprocation of the second piston 1 provides for exhaust of compressed air out of the compression chamber 8 and into the air storage tank 9. This described charging of the air storage tank 9 using compressed air contents from the compression chamber 8 can be done as part of two stroke or four stroke power cycle operation of the stacked piston arrangement 78. The air supply circuit 84 could also have the one or more ports 76 include the second port 36 for directing air with respect to the compression chamber 8 via the ambient control valve 26 coupled to ambient 29 (e.g. for inlet of air from ambient 29 into the compression chamber 8 and/or exhaust of air from the compression chamber 8 into ambient 29). It is also recognized that the second port 36 can be fluidly connected to the air storage tank 9 via the tank control valve 35, thus providing for venting of the compression chamber 8 to tank 9 and/or the supply of compressed air from the tank 9 to the compression chamber 8. It is also recognized that control valve 41 and supply line 42 can also be used to supply air port 44 with compressed air for inlet into the compression chamber 8 and/or for supply air port 44 with compressed air for exit from the compression chamber 8 and into the tank 9.

Referring again to FIGS. 1,2 and 3, shown is the control system 100 having the computer processor 102 and associated memory 104 programmed by the set of stored instructions 106 for executing the instructions 106 to operate in a power cycle (e.g. two stroke, four stroke) using the stacked piston arrangement 78. The control system 100 has the interface 108 for receiving and providing control signals 110 based on information 110 provided by the position sensing system 53, the valve control system 64, states of the various valves (e.g. valves 5, 13, 26, 32, 35, 41, 43), and/or tank 9 pressure monitored by pressure sensor 12.

In operation of the stacked piston arrangement 78, during the power cycle, the stroke includes travel of the stacked piston arrangement 78 from TDC to BDC (see FIG. 5), the control system 100 (see FIG. 3) executes the instructions 106 to: receive via the position sensing system 53 a signal 110 that the stacked piston arrangement 78 is in position for travel towards BDC; open the tank control valve 35 to supply compressed air from the air storage tank 9 into the compression chamber 8; and close the tank control valve 35 to inhibit the supply of compressed air into the compression chamber 8 during travel of the stacked piston arrangement towards TDC; wherein supply of compressed air in the first supply line 6 from the compression chamber 8 to the air storage tank 9 is inhibited by the outlet valve 3 positioned between the compression chamber 8 and the air storage tank 9 while air pressure introduced by the supply of compressed air into the compression chamber 8 biases travel of the stacked piston 78 arrangement towards BDC.

Further to the above, the control system 100 (see FIG. 3) can execute the set of stored instructions 106 to operate the stacked piston arrangement 78 during the power cycle to: during travel of the stacked piston arrangement 78 from BDC to TDC (see FIG. 4), optionally assess if air pressure of the air storage tank 9 is above a pressure threshold, and if so then vent the air storage tank 9. The venting could involve opening the ambient control valve 26,90 to direct the air out of the compression chamber 8 into ambient 29 rather than into the air storage tank 9. Another option is for the control system 100 to execute the set of stored instructions 106 to operate the stacked piston arrangement 78 during the power cycle to: position the tank control valve 35 as closed over a number of the power cycles in series in order to increase the air pressure in the air storage tank 9.

As noted above, the exhaust system 62 coupled to the outlet 19 of the combustion chamber 7 is separate from the sir supply circuit 84 used to supply compressed air for engine start up assist. As such, the one or more ports 76 in the engine block 20 for directing air out of the compression chamber 8 bypasses the exhaust system 62 by the second port 36 for directing air with respect to the compression chamber 8 via the ambient control valve 26 coupled to ambient 29. Further, the one or more ports 76 in the engine block 20 direct air out of the compression chamber 8 by bypassing the exhaust system 62 by the second port 36, 44 fluidly connected to the air storage tank 9 via the control valve 35,41, such that air is circulated between the air storage tank 9 and the compression chamber 8 using the first port 86 and the second port 36,44.

Referring again to FIGS. 1, 2 and 3, shown is the control system 100 having the computer processor 102 and associated memory 104 programmed by the set of stored instructions 106 for executing the instructions 106 to operate in a power cycle (e.g. two stroke, four stroke) using the stacked piston arrangement 78. The control system 100 has the interface 108 for receiving and providing control signals 110 based on information 110 provided by the position sensing system 53, the valve control system 64, states of the various valves (e.g. valves 5, 13, 26, 32, 35, 41, 43), and/or tank 9 pressure monitored by pressure sensor 12.

In operation of the stacked piston arrangement 78, during the power cycle, the stroke including travel of the stacked piston arrangement 78 from BDC to TDC (see FIG. 5) and return (see FIG. 4), the control system 100 (see FIG. 3) executes the instructions 106 to: receive via the position sensing system 53 a signal 110 that the stacked piston arrangement 78 is in position for travel towards BDC; open at least one of the control valve 35,41,44 and the ambient control valve 26 to supply air into the compression chamber 8; and close the at least one of the control valve 35,44 and the ambient control valve 26 to inhibit egress of air from the compression chamber 8 during travel of the stacked piston arrangement towards TDC before reaching alignment of the release port 3 with the air outlet 86; wherein the compression of air in the compression chamber 8 during travel of the stacked piston arrangement 78 towards TDC biases travel of the stacked piston arrangement 78 against travel towards TDC during operation of the combustion chamber 7.

It is recognized that more aggressive braking of the stacked piston arrangement can be provided when compressed air from the air storage tank 9 is introduced to the compression chamber 8 during travel of the stacked piston arrangement 78 towards BDC, as compressed air (having an air pressure greater than ambient air when sourced from ambient 29) is sourced from the air storage tank 9 via supply line(s) 25,42 with appropriate open/close of valves 35,41,44 during intake and compression of air with respect to the compression chamber 8.

Alternatively, less-aggressive braking of the stacked piston arrangement can be provided when ambient air from ambient 29 is introduced to the compression chamber 8 during travel of the stacked piston arrangement 78 towards BDC, as ambient air (having an air pressure less than compressed air when sourced from air storage tank 9) is sourced from ambient 29 via secondary port 36 with appropriate open/close of valve 26 during intake and compression of air with respect to the compression chamber 8.

It is acknowledged that compressed air exiting the compression chamber 8 can be supplied (or resupplied) to the air storage tank 9 during exhaust of the compression chamber 8, as desired, and/or can be vented to ambient 29.

Further to the above, the control system 100 can execute the set of stored instructions 106 to operate the stacked piston arrangement 78 during the power cycle to: during travel of the stacked piston arrangement 78 from BDC to TDC, optionally assessing if air pressure of the air storage tank 9 is above a pressure threshold, and if so then venting the air storage tank 9. The venting can be accomplished by opening the ambient control valve 26 to direct the air out of the compression chamber 8 into ambient rather than into the air storage tank 9 via the first port 86 when the stacked piston arrangement approaches TDC and the alignment of the release port 3 with the air outlet port 86. Alternatively, the set of stored instructions can operate the stacked piston arrangement 78 during the power cycle to close the ambient control valve 26 to direct the air out of the compression chamber 8 and into the air storage tank 9 via the first port 86 rather than into ambient 29 when the stacked piston arrangement 78 approaches TDC.

In the alternative embodiment, in operation of the stacked piston arrangement 78, during the power cycle, the stroke including travel of the stacked piston arrangement 78 from BDC to TDC (see FIG. 5) and return (see FIG. 4), the control system 100 (see FIG. 3) executes the instructions 106 to: receive via the position sensing system 53 a signal 110 that the stacked piston arrangement 78 is in position for travel towards BDC; open at least one of the control valve 35,41,44 and the ambient control valve 26 to supply air into the compression chamber 8; and retain opening of the at least one of the control valve 35,44 and the ambient control valve 26 to facilitate egress of air from the compression chamber 8 during travel of the stacked piston arrangement towards TDC before reaching alignment of the release port 3 with the air outlet 86; wherein the compression of air in the compression chamber 8 during travel of the stacked piston arrangement 78 towards TDC biases travel of the stacked piston arrangement 78 against travel towards TDC during operation of the combustion chamber 7.

As such, in the alternative embodiment, this can also be referred to as a form of non-aggressive braking whereby air (supplied from ambient 29 and/or from the air storage tank 9) in compression chamber 8 undergoing compression is allowed to exit the compression chamber (e.g. via second port 36, 44) before alignment of the release port 3 and first outlet 86 during travel of the stacked piston arrangement 78 towards TDC.

As noted above, the exhaust system 62 coupled to the outlet 19 of the combustion chamber 7 is separate from the air supply circuit 84 (see FIG. 3) used to supply compressed air for engine braking. As such, the one or more ports 76 in the engine block 20 for directing air out of the compression chamber 8 bypasses the exhaust system 62 by the one or more ports 76 including the second port 36 for directing air with respect to the compression chamber 8 via the ambient control valve 26 coupled to ambient 29. Alternatively, the one or more ports 76 in the engine block 20 for directing air out of the compression chamber 8 bypasses the exhaust system 62 by the one or more ports 76 including the second port 36,44 fluidly connected to the air storage tank 9 via the valve 35,43, such that air is circulated between the air storage tank 9 and the compression chamber 8 using the first port 86 and the second port 36,44.

It is also recognized that if the supply of compressed air from the compression chamber 8 is not needed (e.g. the air storage tank 9 is full), the system 100 can be operated by the instructions 106 to cause: as piston 1 moves to BDC, air is drawn into the compression chamber 8 (e.g. via line 45 and check valve 44 and/or via second port 36 such as using valve 26 for air from ambient 29). As piston 1 moves to TDC, air volume in the compression chamber 8 will be compressed according to valve 35 setting. During this condition, air in the compression chamber 8 is forced out past port 36 and controlled by valve 26 to ambient 29, or, out past valve 35, out past line 25 to tank 9. Accordingly, using the second outlet 36, piston 1 can begin to displace air volume from the instant it moves off BDC, therefore, resistance against piston 1 will be reduced during travel from BDC to TDC. It is also recognized that a combination of air exhausted from the compression chamber 8 to a variety of different sinks can be accommodated for in the context of a multi cylinder environment. For example, some of the cylinder exhausts (e.g. via outlets 36, 44, 86) can be supplied to ambient 29 and/or directly to the air storage tank 9 during piston 1 travel while other cylinder exhaust(s) can be supplied to directly to the air storage tank 9 under compression (i.e. delaying exhaust from the compression chamber 8) upon alignment of the release port 3 with outlet port 86. This multi cylinder environment operation can be done via the control system 100 through appropriate selection of the number of cylinders storing (sending to the air storage tank 9 via either supply line 6 or supply line 25,42) verses the number of cylinders venting to ambient via control valve 26,90. Also, a driver could be able to select via input to the control system 100 how aggressive air storing is in relation to the preferred road speeds.

We claim:

1. A piston-cylinder arrangement for an internal combustion engine, the arrangement comprising:
a first cylinder bore in an engine block, the first cylinder bore having an axis extending along a length of the first cylinder bore;
a first piston positioned within the first cylinder bore for reciprocation along the axis;
a combustion chamber positioned between walls of the first cylinder bore and the first piston;
an inlet for directing intake contents into the combustion chamber;
an outlet for directing exhaust contents of the combustion chamber out of the combustion chamber;
a second cylinder bore in the engine block, the second cylinder bore aligned with the first cylinder bore along the axis;
a second piston positioned within the second cylinder bore for reciprocation along the axis;
a compression chamber positioned between walls of the second cylinder bore and the second piston;
one or more ports in the engine block for directing air into and out of the compression chamber; and
one or more supporting members connecting the first piston to the second piston, the one or more supporting members positioning the first piston and the second piston is a spaced apart relationship for facilitating concurrent reciprocation of the first piston and the second piston within their respective cylinder bores during operation of the internal combustion engine;
wherein the first piston, the second piston and the one or more supporting members define a stacked piston arrangement.

2. The arrangement of claim 1 further comprising an air injection port coupled to the inlet for directing compressed air from the compression chamber into the combustion chamber.

3. The arrangement of claim 1 further comprising a compressed air storage tank positioned between the one or more ports and the air injection port, the compressed air storage tank fluidly connected to the one or more ports by a first supply line and fluidly connected to the air injection port by a second supply line.

4. The arrangement of claim 3 further comprising the one or more ports including a first port for directing compressed air from the compression chamber to the air storage tank, the first port cooperating with a release port positioned in the one or more supporting members, wherein periodic alignment between first port and the release port during reciprocation of the second piston provides for exhaust of compressed air out of the compression chamber and into the air storage tank.

5. The arrangement of claim 4 further comprising the one or more ports including a second port for directing air with respect to the compression chamber via an ambient control valve coupled to ambient.

6. The arrangement of claim 5 further comprising the second port fluidly connected to the air storage tank via a tank control valve.

7. The arrangement of claim 2, wherein the inlet and the air injection port are positioned in a cylinder head connected to the engine block.

8. The arrangement of claim 2, wherein the inlet includes an inlet valve for coordinating introduction of air into the combustion chamber via an engine intake port.

9. The arrangement of claim 8, wherein the air injection port is fluidly connected to the engine intake port between an inlet control valve and the inlet valve.

10. The arrangement of claim 3 further comprising a tank supply control valve for controlling supply of compressed air in the second supply line from the air storage tank to the air injection port and an outlet valve for providing supply of compressed air in the first supply line from the compression chamber to the air storage tank.

11. The arrangement of claim 10 further comprising:
a position sensing system for sensing position of the stacked piston arrangement with respect to respective Top Dead Center (TDC) and respective Bottom Dead Center (BDC) of the cylinder bores; and
a valve control system for coordinating opening and closing of an inlet valve of the inlet and an exhaust valve of the outlet.

12. The arrangement of claim 11, wherein the valve control system includes a valve actuator selected from the group consisting of: a cam shaft and an electronically controlled valve actuator.

13. The arrangement of claim 1 further comprising an exhaust system coupled to the outlet of the combustion chamber.

14. The arrangement of claim 13, wherein the one or more ports in the engine block for directing air out of the compression chamber bypasses the exhaust system.

15. The arrangement of claim 14 further comprising the one or more ports including a second port for directing air with respect to the compression chamber via an ambient control valve coupled to ambient.

16. The arrangement of claim 14 further comprising the one or more ports including a second port fluidly connected to the air storage tank via a tank control valve, such that air is circulated between the air storage tank and the compression chamber using the first port and the second port.

17. The arrangement of claim 10 further comprising:
a control system having a computer processor and associated memory programmed by a set of stored instructions for executing the instructions to operate in a power cycle using two strokes of the stacked piston arrangement as:
during a first stroke of the two strokes of the power cycle, the first stroke including travel of the stacked piston arrangement from TDC to BDC:
receiving via the position sensing system a signal that the stacked piston is adjacent to TDC;
providing for inlet of air from ambient into the compression chamber;
opening the tank supply control valve to supply compressed air from the air storage tank to the air inlet port for injection into the combustion chamber via the inlet, the compressed air for use in mixing with fuel for facilitating combustion in the combustion chamber during the first stroke; and
during a second stroke of the two strokes of the power cycle, the second stroke including travel of the stacked piston arrangement from BDC to TDC:
assessing if air pressure of the air storage tank is above a pressure threshold, and if so then venting the air storage tank;
wherein exhaust contents present in the combustion chamber are expelled from the combustion chamber during the second stroke through operation of an exhaust valve in the outlet via the valve control system.

18. The arrangement of claim 17, wherein the ambient control valve is opened to facilitate the venting.

19. The arrangement of claim 17, wherein the stacked piston arrangement is traveling towards TDC when the tank supply control valve is opened.

20. The arrangement of claim 17, wherein the stacked piston arrangement is traveling towards BDC when the tank supply control valve is opened.

21. The arrangement of claim 17 further comprising the set of stored instructions to operate in the power cycle during the first stroke of the two strokes of the power cycle as:
positioning the tank supply control valve as closed in order to inhibit the supply of compressed air into the inlet; wherein the internal combustion engine operates in a normally aspirated mode using ambient air collected via the inlet.

22. The arrangement of claim 21 further comprising the one or more ports including a second port for directing air with respect to the compression chamber via an ambient control valve coupled to ambient, the second port separate from the first port.

23. The arrangement of claim 22 further comprising the set of stored instructions to operate in the power cycle during the second stroke of the two strokes of the power cycle as:
opening the ambient control valve to direct the air out of the compression chamber into ambient rather than into the air storage tank via the first port.

24. The arrangement of claim 17 further comprising the set of stored instructions to operate in the power cycle as:
positioning the tank supply control valve as closed over a number of the power cycles in series in order to inhibit the supply of compressed air into the inlet while increasing the air pressure in the air storage tank;
wherein the internal combustion engine operates in a normally aspirated mode using ambient air collected via the inlet.

25. The arrangement of claim 17, wherein the internal combustion engine is selected from the group consisting of a petrol fueled engine and a diesel fueled engine.

26. The arrangement of claim 17 further comprising an exhaust system coupled to the outlet of the combustion chamber.

27. The arrangement of claim 26, wherein the one or more ports in the engine block for directing air out of the compression chamber bypasses the exhaust system by the one or more ports includes a second port for directing air with respect to the compression chamber via an ambient control valve coupled to ambient.

28. The arrangement of claim 26, wherein the one or more ports in the engine block for directing air out of the compression chamber bypasses the exhaust system by a second port fluidly connected to the air storage tank via a tank control valve, such that air is circulated between the air storage tank and the compression chamber using the first port and the second port.

29. The arrangement of claim 1 further comprising a compressed air storage tank fluidly connected to the one or more ports by a first supply line for storing compressed air generated during operation of the internal combustion engine.

30. The arrangement of claim 29 further comprising the one or more ports including a first port for directing compressed air from the compression chamber to the air storage tank, the first port cooperating with a release port positioned in the one or more supporting members, wherein periodic alignment between first port and the release port during reciprocation of the second piston provides for exhaust of compressed air out of the compression chamber and into the air storage tank.

31. The arrangement of claim 29 further comprising the one or more ports including a second port for directing air with respect to the compression chamber via an ambient control valve coupled to ambient.

32. The arrangement of claim 30 further comprising the second port fluidly connected to the air storage tank via a tank control valve.

33. The arrangement of claim 32 further comprising:
a control system having a computer processor and associated memory programmed by a set of stored instructions for executing the instructions to operate in a power cycle of the stacked piston arrangement as:
receiving via the position sensing system a signal that the stacked piston arrangement is in position for travel towards BDC;
opening the tank control valve to supply compressed air from the air storage tank into the compression chamber; and
closing the tank control valve to inhibit the supply of compressed air into the compression chamber during travel of the stacked piston arrangement towards TDC;
wherein supply of compressed air in the first supply line from the compression chamber to the air storage tank is inhibited by an outlet valve positioned between the compression chamber and the air storage tank while air pressure introduced by the supply of compressed air into the compression chamber biases travel of the stacked piston arrangement towards BDC.

34. The arrangement of claim 33 further comprising the set of stored instructions to operate the stacked piston arrangement during the power cycle as:
during travel of the stacked piston arrangement from BDC to TDC, assessing if air pressure of the air storage tank is above a pressure threshold, and if so then venting the air storage tank.

35. The arrangement of claim 33 further comprising the set of stored instructions to operate the stacked piston arrangement during the power cycle as:
opening the ambient control valve to direct the air out of the compression chamber into ambient rather than into the air storage tank via the first port.

36. The arrangement of claim 33 further comprising the set of stored instructions to operate the stacked piston arrangement during the power cycle as:
position the tank supply control valve as closed over a number of the power cycles in series in order to increase the air pressure in the air storage tank.

37. The arrangement of claim 33 further comprising an exhaust system coupled to the outlet of the combustion chamber.

38. The arrangement of claim 37, wherein the one or more ports in the engine block for directing air out of the compression chamber bypasses the exhaust system by the second port for directing air with respect to the compression chamber via the ambient control valve coupled to ambient.

39. The arrangement of claim 37, wherein the one or more ports in the engine block for directing air out of the compression chamber bypasses the exhaust system by the second port fluidly connected to the air storage tank via the tank control valve, such that air is circulated between the air storage tank and the compression chamber using the first port and the second port.

40. The arrangement of claim 32 further comprising:
a control system having a computer processor and associated memory programmed by a set of stored instructions for executing the instructions to operate in a power cycle of the stacked piston arrangement as:
receiving via the position sensing system a signal that the stacked piston arrangement is in position for travel towards BDC;
opening at least one of the tank control valve and the ambient control valve to supply air into the compression chamber; and
closing the at least one of the tank control valve and the ambient control valve to inhibit egress of air from the compression chamber during travel of the stacked piston arrangement towards TDC;
wherein the compression of air in the compression chamber during travel of the stacked piston arrangement towards TDC biases travel of the stacked piston arrangement against travel towards TDC during operation of intake and exhaust in the combustion chamber.

41. The arrangement of claim 40 further comprising the set of stored instructions to operate the stacked piston arrangement during the power cycle as:
during travel of the stacked piston arrangement from BDC to TDC, assessing if air pressure of the air storage tank is above a pressure threshold, and if so then venting the air storage tank.

42. The arrangement of claim 40 further comprising the set of stored instructions to operate the stacked piston arrangement during the power cycle as:
opening the ambient control valve to direct the air out of the compression chamber into ambient rather than into the air storage tank via the first port when the stacked piston arrangement approaches TDC.

43. The arrangement of claim 40 further comprising the set of stored instructions to operate the stacked piston arrangement during the power cycle as:
closing the ambient control valve to direct the air out of the compression chamber into the air storage tank via the first port rather than into ambient when the stacked piston arrangement approaches TDC.

44. The arrangement of claim 40 further comprising the set of stored instructions to operate the stacked piston arrangement during the power cycle as:
position the tank supply control valve as closed over a number of the power cycles in series in order to increase the air pressure in the air storage tank.

45. The arrangement of claim 40 further comprising an exhaust system coupled to the outlet of the combustion chamber.

46. The arrangement of claim 45, wherein the one or more ports in the engine block for directing air out of the compression chamber bypasses the exhaust system by the one or more ports including the second port for directing air with respect to the compression chamber via the ambient control valve coupled to ambient.

47. The arrangement of claim 45, wherein the one or more ports in the engine block for directing air out of the compression chamber bypasses the exhaust system by the one or more ports including the second port fluidly connected to the air storage tank via the tank control valve, such that air is circulated between the air storage tank and the compression chamber using the first port and the second port.

48. The arrangement of claim 10 further comprising:
a control system having a computer processor and associated memory programmed by a set of stored instructions for executing the instructions to operate in a power cycle using four strokes of the stacked piston arrangement as:
during a first stroke of the four strokes of the power cycle, the first stroke including travel of the stacked piston arrangement from TDC to BDC:
receiving via the position sensing system a signal that the stacked piston is adjacent to TDC;
providing for inlet of air from ambient into the compression chamber;
opening the tank supply control valve to supply compressed air from the air storage tank to the air inlet port for injection into the combustion chamber via the inlet, the compressed air for use in mixing with fuel for facilitating combustion in the combustion chamber during a second stroke of the power cycle; and
during at least one of a second stroke and a fourth stroke of the power cycle, the second stroke and the fourth stroke including travel of the stacked piston arrangement from BDC to TDC:
assessing if air pressure of the air storage tank is above a pressure threshold, and if so then venting the air storage tank;
wherein exhaust contents present in the combustion chamber are expelled from the combustion chamber during the fourth stroke through operation of an exhaust valve in the outlet via the valve control system.

49. The arrangement of claim 48, wherein the ambient control valve is opened to facilitate the venting.

50. The arrangement of claim 48, wherein the stacked piston arrangement is traveling towards TDC when the tank supply control valve is opened.

51. The arrangement of claim 48, wherein the stacked piston arrangement is traveling towards BDC when the tank supply control valve is opened.

52. The arrangement of claim 48 further comprising the set of stored instructions to operate in the power cycle during the first stroke of the four strokes of the power cycle as:
positioning the tank supply control valve as closed in order to inhibit the supply of compressed air into the inlet; wherein the internal combustion engine operates in a normally aspirated mode using ambient air collected via the inlet.

53. The arrangement of claim 52 further comprising the one or more ports including a second port for directing air with respect to the compression chamber via an ambient control valve coupled to ambient, the second port separate from the first port.

54. The arrangement of claim 53 further comprising the set of stored instructions to operate in the power cycle during at least one of the second stroke and the fourth stroke of the power cycle as:
opening the ambient control valve to direct the air out of the compression chamber into ambient rather than into the air storage tank via the first port.

55. The arrangement of claim 48 further comprising the set of stored instructions to operate in the power cycle as:
positioning the tank supply control valve as closed over a number of the power cycles in series in order to inhibit the supply of compressed air into the inlet while increasing the air pressure in the air storage tank;
wherein the internal combustion engine operates in a normally aspirated mode using ambient air collected via the inlet.
